(19) United States
(12) Patent Application Publication
(10) Pub. No.: US 2008/0115715 A1
(43) Pub. Date: May 22, 2008

(54) Floating module and modular floating structure with variable configuration

(75) Inventors: Francesco Del Tosto, Roma (IT); Romano Tucci, Fiano Romano (IT)

Correspondence Address: MODIANO & ASSOCIATI, Via Meravigli, 16, MILAN, 20123, omitted

(73) Assignee: INSULAE NATANTES S.R.L.

(21) Appl. No.: 11/808,792

(22) Filed: Jun. 13, 2007

(30) Foreign Application Priority Data
Nov. 22, 2006 (IT) MI2006A002238

(51) Int. Cl. B63B 35/44; G05D 3/00

(52) U.S. Cl. 114/266; 701/21

(57) ABSTRACT

A floating module, particularly for providing modular floating structures, comprising a tubular body open at its lower end, which is designed to be directed toward the seabed, and provided, at its upper end, with a closure element which is provided with at least one opening for injecting compressed air into the tubular body, connection elements being provided in order to connect the tubular body to one or more adjacent tubular bodies.

The present invention relates to a floating module and to a corresponding modular floating structure with variable configuration, which allows to provide for example a floating port terminal which is adapted for the transfer and storage of containers and the like.

More particularly, the invention relates to a modular floating structure which is capable of bearing permanent and live loads of a few tons per square meter with variable load scenarios.

### BACKGROUND OF THE INVENTION

As is known, floating structures of the following types are commercial available:
large monolithic reinforced-concrete or prestressed-concrete structures shaped like multicellular caissons which are manufactured specifically in large docks which are generally located very far from the place of use and are then transported to the place of use;
modular steel structures, such as modular pontoons which are also connected by lattice-like structures.

However, conventional solutions suffer drawbacks due to the limited life of the structure, its excessive weight, particularly for reinforced concrete structures, its high rigidity, the intense stresses associated in particular with the transport, the need to have enormous docks for their construction, their environmental impact, et cetera. Such drawbacks have affected negatively the construction and management cost, holding back the development of this type of structure, and have substantially limited its use to a small number of particular applications.

### SUMMARY OF THE INVENTION

The aim of the present invention is to provide a floating module and a corresponding modular floating structure which can have a variable configuration once it is placed in water.

Within this aim, an object of the present invention is to provide a floating module and a corresponding modular floating structure which, despite low costs and constructive simplicity, can compete with known types of structures, such as piers on pillars or embankments delimited by caissons placed on an appropriately prepared bed.

Another object of the present invention is to provide a modular floating structure whose expandability can be provided very simply according to the requirements.

Another object of the present invention is to provide a floating module and a corresponding modular floating structure which allow to have a surface which is rigid enough to absorb deformations imparted by moving loads.

Still another object of the present invention is to provide a floating module and a corresponding modular floating structure which are highly reliable, relatively simple to provide and at competitive costs.

This aim and these and other objects, which will become better apparent hereinafter, are achieved by a floating module, particularly for providing modular floating structures, characterized in that it comprises a tubular body open at its lower end, which is designed to be directed toward the seabed, and provided, at its upper end, with a closure element which is provided with at least one opening for injecting compressed air into said tubular body, connection means being provided in order to connect said tubular body to one or more adjacent tubular bodies.

### BRIEF DESCRIPTION OF THE DRAWINGS

Further characteristics and advantages of the invention will become better apparent from the description of a preferred but not exclusive embodiment of the floating structure according to the invention, illustrated by way of non-limiting example in the accompanying drawings, wherein:

FIG. 1 is a partially cutout perspective view of the floating structure according to the present invention;

FIG. 2 is a side elevation view of the floating structure according to the present invention, arranged in an operating environment;

FIG. 3 is a perspective view of a plurality of floating modules, which are interconnected in order to form a floating structure according to the invention;

FIGS. 4a, 4b and 4c respectively illustrate an initial condition, without load, and two loaded conditions of the structure according to the present invention.

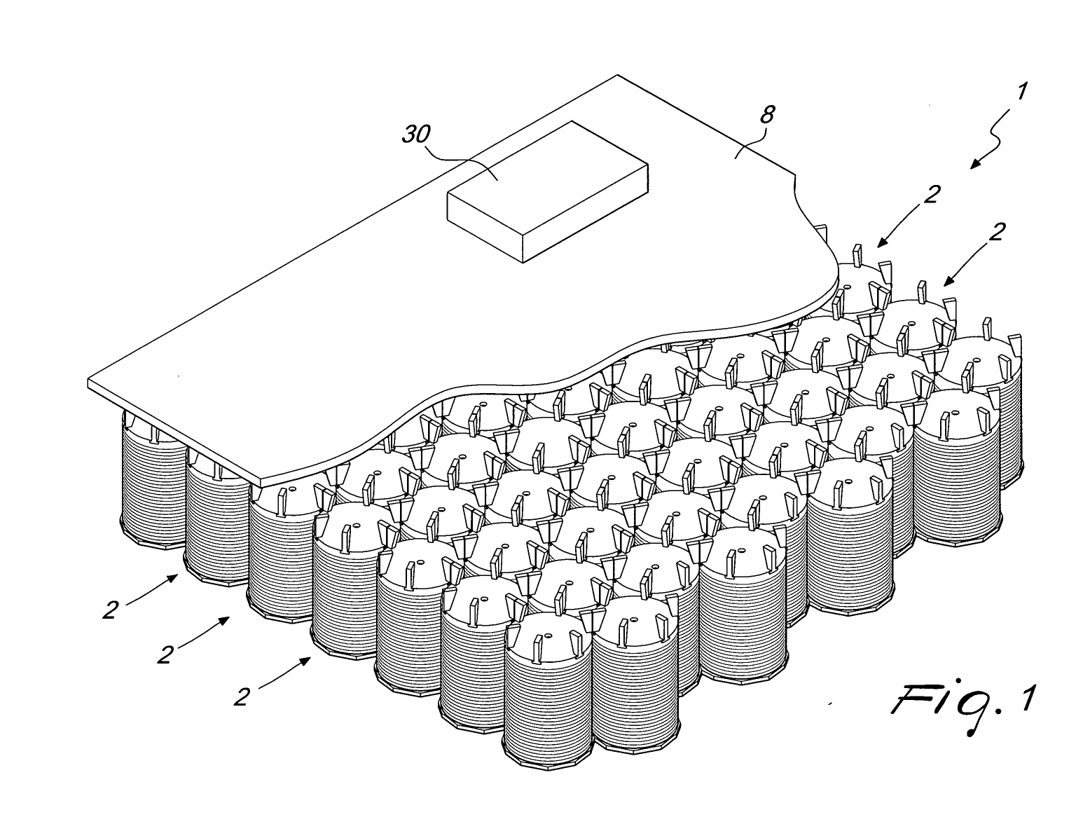

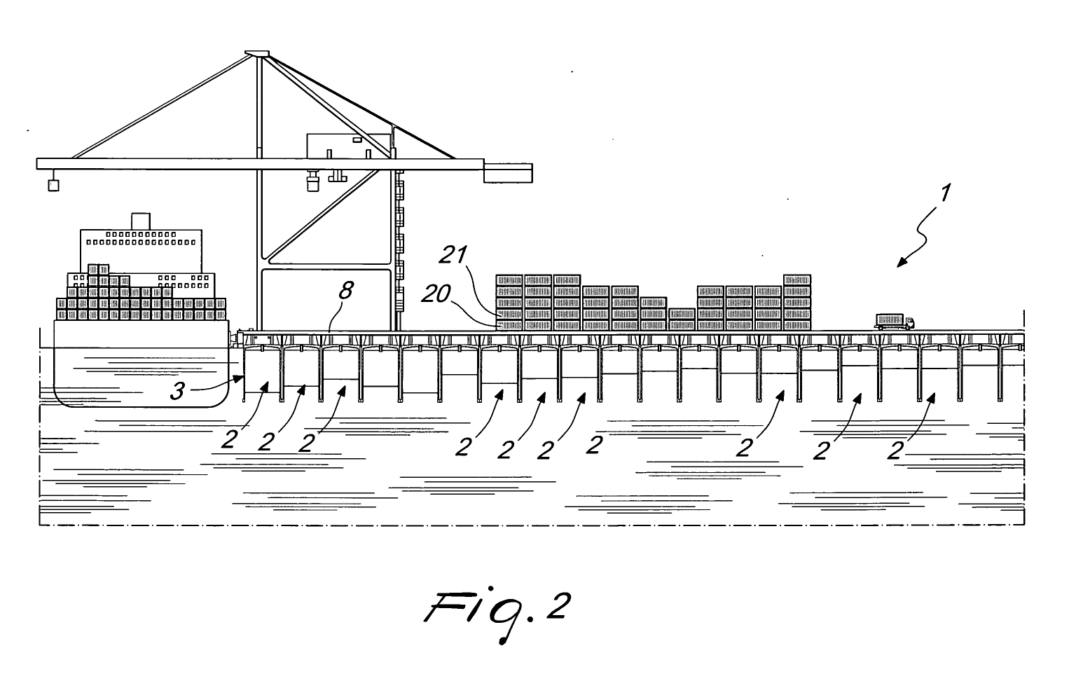

### DESCRIPTION OF THE PREFERRED EMBODIMENTS

With reference to the figures, the floating structure according to the present invention, generally designated by the reference numeral 1, comprises a plurality of floating modules 2, each provided as follows.

Each floating module 2 comprises a tubular body or element 3, which is for example cylindrical, is open in a downward region, and is provided in an upward region with a closure element 4, provided for example with a concavity which is directed downwardly.

The closure element 4 is provided with at least one opening or hole 5 for injecting compressed air into the internal space 6 formed by the tubular element 3.

The compressed air is injected by means of compressed air ducts 7 which are accommodated above the closure element 4 and are contained between the closure element 4 and a slab or covering element 8 made for example of reinforced concrete, which acts as a working surface.

The covering element 8 is preferably curved at the inner surface and flat at the outer surface.

The closure element 4, arranged below the working surface 8, provides a utility surface which is adapted for the insertion of systems and sensors.

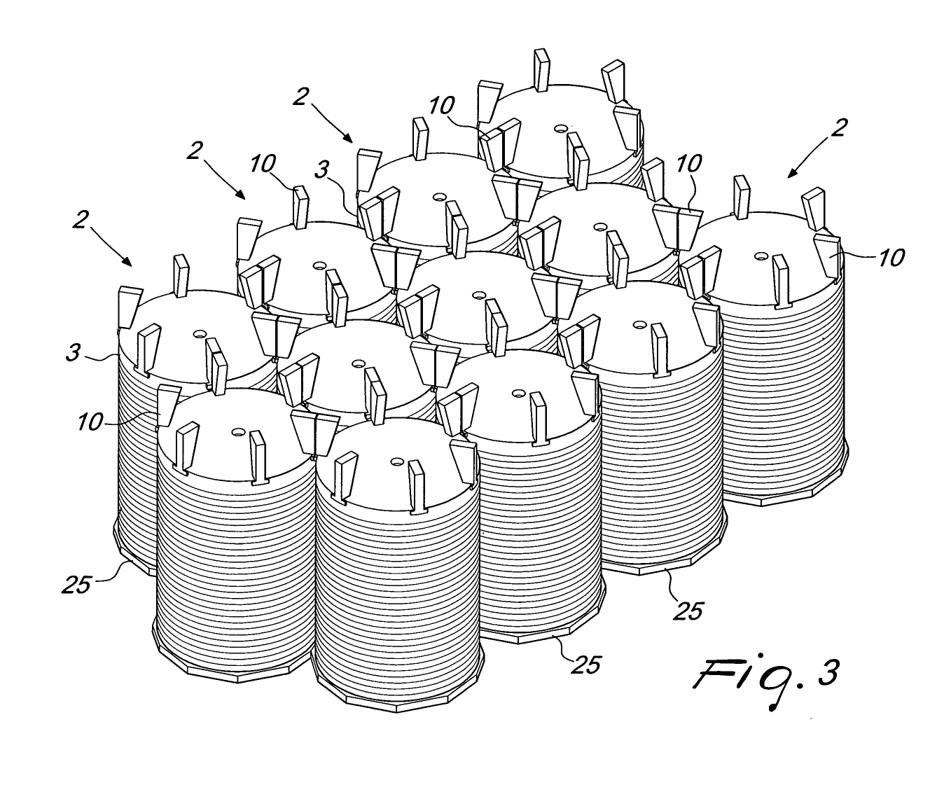

As shown for example in FIG. 3, each tubular element 3 is provided with a plurality of protruding supporting elements 10, which rise like teeth from the upper surface of the tubular element 3. Such elements are designed, among other things, to connect the modules to each other, to connect the modules to the working slab, and to accommodate the stress sensors.

In this manner, it is possible to assemble a modular structure, as shown for example in FIG. 3, in which a plurality of floating modules 2 are joined together by way of the connection means 10 and by the connection of flanges 25 arranged on the lower edge of the module 2.

Advantageously, the modules 2 are produced and manufactured for example by using lightweight concrete and composite materials (glass fibers, carbon fibers, PVA fibers, stainless steel, et cetera) and constitute tanks into which compressed air which arrives from above is introduced by means of ducts fed by compressors and controlled by valves.

The modules 2 are floating modules, so as to minimize the environmental impact on the coasts and on the seabed, are filled partially (and variably) with air and are directly in contact, in their lower part, with the fluid on which they float, i.e., seawater, for example, so that they can be inspected also internally.

The level of the fluid inside the floating modules is adjustable according to the amount of air which is injected.

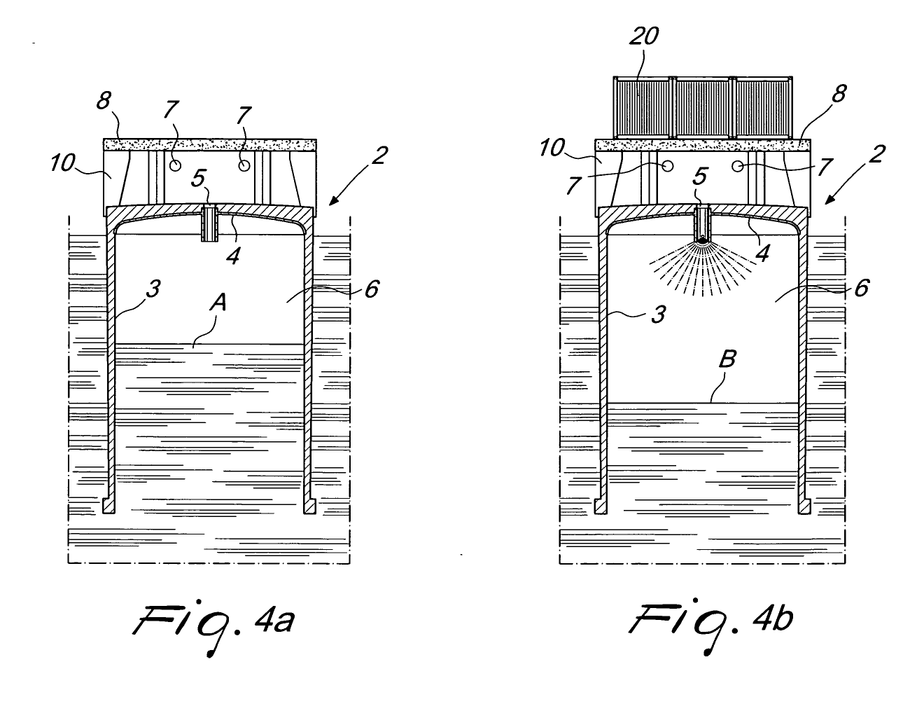

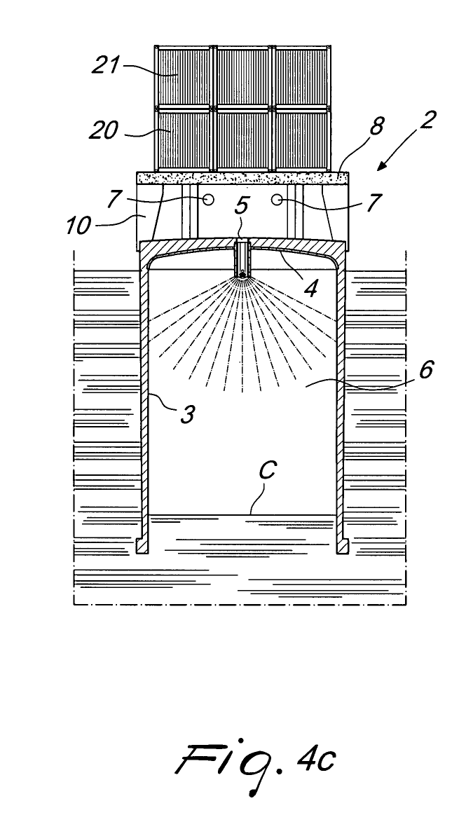

As shown in FIG. 4a, the floating module in this case is in a condition in which it floats without injecting compressed air, and therefore the level of the liquid reaches a height A.

In FIG. 4b, a load 20 is placed on the reinforced concrete slab 8, which constitutes the loading surface on which the load is to be placed above each floating module 2, and in this case, in order to keep the floating module at the same height with respect to the floating module of FIG. 4a, it is necessary to inject compressed air and therefore the level of the fluid reaches a height B, which is lower than the height A.

Finally, FIG. 4c illustrates the situation in which a double load 20 and 21 is applied to the slab 8 and therefore, in order to keep the floating module 2 at the same height with respect to the modules of FIGS. 4a and 4b, it is necessary to inject even more compressed air, and therefore the level of the fluid within the floating module 2 is at a height C which is lower than the height B.

Therefore as can be seen, the flotation of the module 2 is modified by injecting compressed air, depending on the amount of load applied to the slab 8, with the goal of keeping the module floating always at the same height regardless of the load placed thereon.

This allows to have a modular floating structure which is formed by a plurality of interconnected floating modules and can support a variable load, without its flotation being affected, since it is possible to modify such flotation by injecting more or less compressed air into each floating module 2 in proportion to the load applied to the slab 8.

Conveniently, on the slab 8 there is at least one technical compartment 30, which is adapted to contain the compressors for injecting compressed air and the systems for controlling the amount of injected compressed air.

Conveniently, each module 2 has, at its open bottom, a flange 25 which is substantially polygonal and allows to make adjacent modules 2 meet, such modules also having polygonal flanges 25, so as to create a compact structure which can be compared to the upper slab 8, thus forming substantially a sort of sandwich panel comprised between two outer plates, the upper plate being constituted by the reinforced concrete slab 8 arranged at a higher level than the average sea level and capable of distributing the extremely high loads which are concentrated on its surface and of protecting the “mattress” constituted by the plurality of interconnected modules 2, while the lower plate is constituted by the set of the bottoms or flanges 25 of the modules 2, which are appropriately stiffened and clamped to each other.

Therefore, the structure thus formed allows, as the load varies, to vary the amount of air in each module 2, with the intent of keeping the pier surface horizontal and of reducing the flexural stresses which act on the plurality of interconnected modules 2.

As can be seen, therefore, the operating principle is based on the balance between the weight force of the structure and the buoyancy provided by the floating tanks.

As the weight of the transiting load varies, the integrated control system reacts by varying the amount of air inside each module 2, in order to keep constant both the height of the loading surface (slab 8) with respect to the level of the water and the compression/traction stresses to which such loading surface is subjected.

The integrated management system, by acquiring a set of measurements which arrive both from force transducers which are rigidly coupled to the loading surface 8 and from devices for measuring the level of the free surface of the water or the pressure inside the modular element 2, calculates a map of the distribution of forces of said surface, to which the system reacts in order to have a uniform distribution of compression stresses and minimize traction stresses.

Advantageously, the integrated management system can be constituted for example by a server which comprises a computer with boards which are dedicated to the acquisition of the monitored values, and a dedicated real-time software for the control and management activity. The system further comprises a remote client, constituted by a computer which is connected via an intranet/telephone network for monitoring the main status variables and values measured of the process, by means of overview panels.

In practice it has been found that the floating structure according to the present invention, and in particular each floating module, fully achieve the intended aim and objects, since they allow to provide a flat surface, which has a plan extension of substantially any size at will which is capable of withstanding permanent and live loads of a few tons per square meter with loading scenarios which can vary in any manner.

The structure thus conceived allows to provide for example floating port terminals which are adapted for the transfer or storage of containers and are therefore capable of accommodating any type of pier crane, including larger cranes and cranes for moving within yards.

The floating structure and the floating module thus conceived are susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. MI2006A002238 from which this application claims priority are incorporated herein by reference.

What is claimed is:

1. A floating module, particularly for providing modular floating structures, comprising a tubular body open at a lower end thereof, which is designed to be directed toward the seabed, and provided, at an upper end thereof, with a closure element which is provided with at least one opening for injecting compressed air into said tubular body, connection means being provided in order to connect said tubular body to one or more adjacent tubular bodies.

2. The floating module according to claim 1, further comprising, at the top, above said closure element, a covering element which is adapted to form a loading platform for said tubular body.

3. The floating module according to claim 1, wherein said closure element forms a loading surface for installing systems and sensors, said surface being arranged below said covering element.

4. The floating module according to claim 1, wherein said modular body has, at its upper end, which lies opposite the lower end, a plurality of teeth provided with a slot, which are adapted to allow the engagement of said connection means in order to connect adjacent modular bodies.

5. The floating module according to claim 3, further comprising, between said covering element and said loading surface, means for injecting air into said tubular body.

6. The floating module according to claim 1, further comprising, at said bottom end, a flange which is adapted to allow coupling with flanges of adjacent modular bodies.

7. The floating module according to claim 2, wherein said covering element is curved at an inner surface directed towards said tubular body and flat at an outer surface.

8. A floating structure, comprising a plurality of floating modules according to claim 1 which are interconnected so as to be adjacent to each other.

9. The floating structure according to claim 8, wherein a loading platform is arranged monolithically so as to cover said plurality of floating modules.

10. The floating structure according to claim 8, further comprising means for controlling injection of air into said floating modules.

11. The floating structure according to claim 10, wherein said control means comprise a data acquisition system, for acquiring data which arrive from force transducers which are rigidly coupled to said loading surface and data which arrive from devices for measuring a level of a free surface of water inside said modules or an internal pressure of said module in order to vary the amount of air which is present within said floating modules, so as to keep constant both a height of said loading surface with respect to the water level and compression/traction stresses to which said loading surface is subjected.
